(19) United States
(12) Patent Application Publication
(10) Pub. No.: US 2025/0303949 A1
(43) Pub. Date: Oct. 2, 2025

(54) Work Vehicle

(71) Applicant: Kubota Corporation, Osaka-shi (JP)

(72) Inventor: Tomoki Tate, Osaka (JP)

(21) Appl. No.: 18/974,228

(22) Filed: Dec. 9, 2024

(30) Foreign Application Priority Data
Mar. 27, 2024 (JP) 2024-051422

(51) Int. Cl. B60N 3/02; B60N 3/10; B60R 21/06

(52) U.S. Cl. CPC B60N 3/02; B60N 3/102; B60R 21/06

(57) ABSTRACT

A work vehicle includes an occupant space configured to accommodate an occupant; an arch-shaped frame extending over the occupant space and including a lateral frame portion extending laterally relative to a body of the work vehicle; a left vertical frame portion extending downward from a left end portion of the lateral frame portion; and a right vertical frame portion extending downward from a right end portion of the lateral frame portion; a handrail usable by an occupant on a back seat and including: a first section extending laterally relative to the body; a second section extending forward from a left end portion of the first section; and a third section extending forward from a right end portion of the first section, the second section being coupled to the left vertical frame portion, the third section being coupled to the right vertical frame portion.

### CROSS-REFERENCE TO RELATED APPLICATION

This application claims priority to Japanese Patent Application No. 2024-051422 filed Mar. 27, 2024, the disclosure of which is hereby incorporated by reference in its entirety.

### BACKGROUND OF THE INVENTION

### Field of the Invention

The present invention relates to a work vehicle.

### Description of Related Art

Japanese Unexamined Patent Application Publication, Tokukai, No. 2021-134770 (JP 2021-134770), for example, discloses a work vehicle having a space for occupants. The occupant space contains front seats and back seats backward of the front seats relative to the vehicle body.

The work vehicle also includes a roll-over protective structure (ROPS) for protecting occupants.

The work vehicle disclosed in JP 2021-1347701 may be modified by including a handrail usable by occupants on the back seats for improved convenience for the occupants.

JP 2021-134770 does not describe the ROPS in detail. The ROPS may include an arch-shaped frame extending over the occupant space and including a lateral frame portion extending laterally relative to the vehicle body, a left vertical frame portion extending downward from a left end portion of the lateral frame portion, and a right vertical frame portion extending downward from a right end portion of the lateral frame portion.

The ROPS may be provided with a reinforcing frame member disposed below the lateral frame portion, connecting the left and right vertical frame portions, and provided with the above handrail attached thereto. This allows the reinforcing frame member to ensure the strength of the arch-shaped frame.

Such a configuration, however, tends to involve many parts, leading to an increase in the cost of producing a work vehicle.

### SUMMARY OF THE INVENTION

The present invention has an object of providing a work vehicle that offers improved convenience for occupants on back seats without increasing the production cost.

A work vehicle according to the present invention includes: an occupant space configured to accommodate an occupant; an arch-shaped frame extending over the occupant space and including: a lateral frame portion extending laterally relative to a body of the work vehicle; a left vertical frame portion extending downward from a left end portion of the lateral frame portion; and a right vertical frame portion extending downward from a right end portion of the lateral frame portion; a front seat in the occupant space; a back seat in the occupant space and backward of the front seat relative to the body; and a handrail usable by an occupant on the back seat and including: a first section extending laterally relative to the body; a second section extending forward from a left end portion of the first section; and a third section extending forward from a right end portion of the first section, the second section being coupled to the left vertical frame portion, the third section being coupled to the right vertical frame portion.

The above configuration allows the left and right vertical frame portions to be coupled to each other with the handrail in-between, thereby allowing the handrail to ensure the strength of the arch-shaped frame. The above configuration reduces the number of parts involved, as compared to a case of including a handrail as well as a reinforcing frame member separately from the handrail to couple the left and right vertical frame portions each other, and thereby prevents an increase in the production cost.

The above configuration allows the first section to be backward, as compared to a case of a handrail including no second section or third section. The above handrail is thus easily usable for a user with relatively short arms such as a child, thereby providing improved convenience for an occupant on the back seat.

The work vehicle thereby offers improved convenience for occupants on back seats without increasing the production cost.

The work vehicle may preferably further include: a coupler extending from the handrail to the front seat and coupling the handrail to the front seat.

The above configuration allows the front seat to be coupled to the arch-shaped frame with the coupler and the handrail in-between, thereby ensuring the strength of the front seat.

The work vehicle may preferably be configured such that the first section has an upper end below an upper end of the front seat.

The above configuration prevents the first section from narrowing the forward view of an occupant on a back seat, thereby providing improved convenience for an occupant on the back seat.

The work vehicle may preferably be configured such that the handrail is made of metal.

The above configuration allows the left and right vertical frame portions to be coupled to each other with use of a metal handrail, thereby reliably ensuring the strength of the arch-shaped frame.

The work vehicle may preferably further include: a drink holder attached to the first section.

The above configuration eliminates the need to include a dedicated member for attaching a drink holder, thereby reducing the number of parts involved.

### BRIEF DESCRIPTION OF THE DRAWINGS

FIG. 1 is a left side view of a work vehicle.

FIG. 2 is a left side view of a work vehicle, illustrating elements such as an occupant space.

FIG. 3 is a cross-sectional front view of a work vehicle, illustrating elements such as an arch-shaped frame.

FIG. 4 is a plan view of a work vehicle, illustrating elements such as an arch-shaped frame.

FIG. 5 is a plan view of a work vehicle, illustrating elements such as a handrail.

FIG. 6 is a rear view of a left vertical frame portion and a second section, illustrating their coupling structure.

FIG. 7 is a cross-sectional plan view of a left vertical frame portion and a second section, illustrating their coupling structure.

FIG. 8 is a cross-sectional left side view of elements such as a coupler.

FIG. 9 is a cross-sectional left side view of elements such as a drink holder.

FIG. 10 is a left side view of elements such as first and second supports.

FIG. 11 is an exploded perspective view of elements such as first and second supports.

FIG. 12 is a cross-sectional plan view of a door and a flat surface, illustrating how the door is in contact with the flat surface.

FIG. 13 is a cross-sectional front view of a door and a flat surface, illustrating how the door is in contact with the flat surface.

FIG. 14 is a rear view of elements such as a net.

FIG. 15 is a cross-sectional left side view of a net.

FIG. 16 is a left side view of a back frame portion and a net, illustrating their coupling structure.

### DESCRIPTION OF THE INVENTION

The description below deals with an embodiment of the present invention with reference to drawings. Unless otherwise specified, the description below uses terms such as “front” and “forward” to refer to the direction indicated with arrow F in the drawings, terms such as “back” and “backward” to refer to the direction indicated with arrow B in the drawings, terms such as “left” and “leftward” to refer to the direction indicated with arrow L in the drawings, terms such as “right” and “rightward” to refer to the direction indicated with arrow R in the drawings, terms such as “above” and “upward” to refer to the direction indicated with arrow U in the drawings, and terms such as “below” and “downward” to refer to the direction indicated with arrow D in the drawings.

### Overall Configuration of Work Vehicle

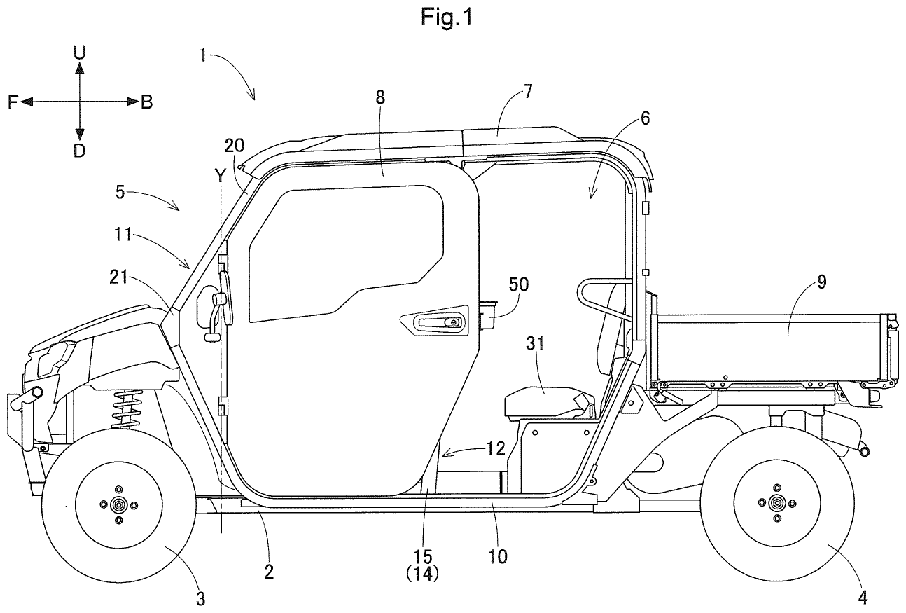

FIG. 1 illustrates a work vehicle 1 in the form of a utility vehicle. As illustrated in FIG. 1, the work vehicle 1 includes a body frame 2, a pair of left and right front wheels 3, and a pair of left and right rear wheels 4 all at a lower portion of the body of the work vehicle 1.

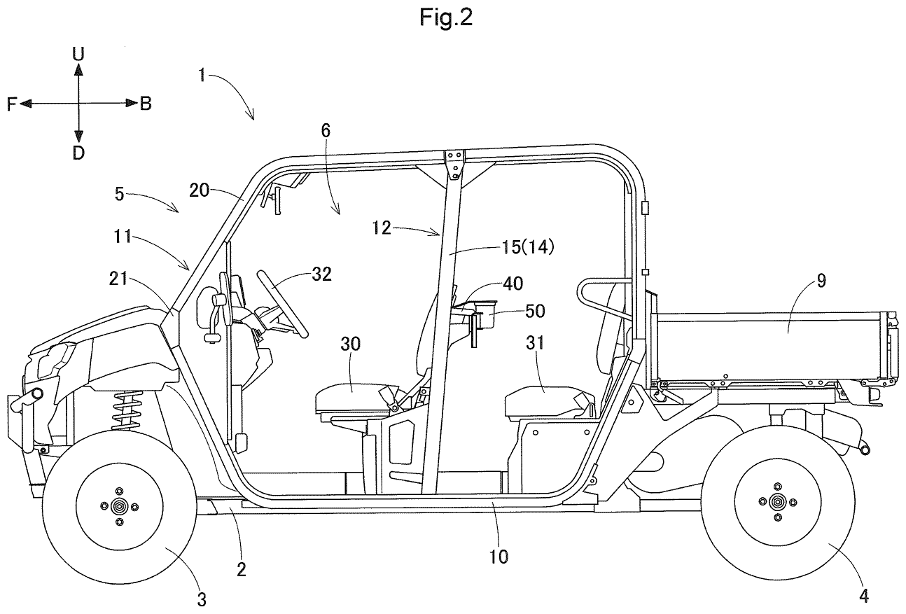

The work vehicle 1 includes a driver section 5 at a central portion in the front-back direction. As illustrated in FIGS. 1 and 2, the driver section 5 includes an occupant space 6, a roof 7, and a door 8. The occupant space 6 is configured to accommodate occupants. The roof 7 is at an upper portion of the body of the work vehicle 1, and defines the upper side of the occupant space 6.

The door 8 is at a left portion of the body of the work vehicle 1, and defines at least a portion of a side of the occupant space 6 which side is lateral relative to the body, specifically, that side of a front portion of the occupant space 6 which is on the left relative to the body.

As described above, the work vehicle 1 includes an occupant space 6 configured to accommodate an occupant and a door 8 facing at least a portion of a side of the occupant space 6 which side is lateral relative to the body. The work vehicle 1 may include two doors 8 at respective left and right portions of the body or a single door 8 at a left or right portion of the body.

The work vehicle 1 includes a cargo box 9 backward of the driver section 5, that is, backward of the occupant space 6 relative to the body.

As described above, the work vehicle 1 includes a cargo box 9 backward of the occupant space 6 relative to the body.

The cargo box 9 is configured to receive a transport object (that is, a cargo such as straw or crops). The work vehicle 1 includes below the cargo box 9 an engine (not illustrated in the drawings) configured to transmit motive power to the front and rear wheels 3 and 4 to drive the front and rear wheels 3 and 4, which in turn allows the work vehicle 1 to travel.

### Structure of Frame for Driver Section

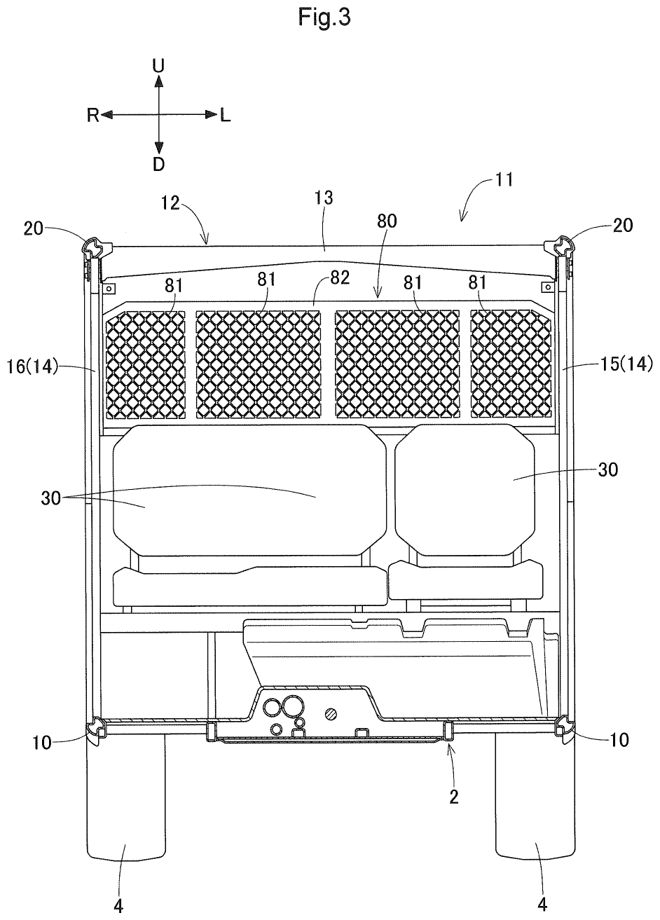

As illustrated in FIGS. 2 and 3, the driver section 5 includes a pair of left and right lower frame portions 10 at respective lower left and lower right portions of the body of the work vehicle 1.

The lower frame portions 10 are coupled to the body frame 2, and extend in the front-back direction relative to the body. The lower frame portions 10 each include a front portion bent obliquely upward, a back portion bent obliquely upward, and a horizontal portion intermediate in the front-back direction relative to the body.

As illustrated in FIGS. 2 to 4, the driver section 5 includes a protective frame 11 in the form of a rollover protection structure (ROPS) supported by the lower frame portions 10 and serving to define the occupant space 6.

The protective frame 11 includes an arch-shaped frame 12 extending over the occupant space 6.

As described above, the work vehicle 1 includes an arch-shaped frame 12 extending over the occupant space 6.

As illustrated in FIG. 3, the arch-shaped frame 12 includes a lateral frame portion 13 and a pair of left and right vertical frame portions 14. The lateral frame portion 13 is at an upper portion of the body of the work vehicle 1, and extends laterally relative to the body.

The vertical frame portions 14 extend downward from respective left and right end portions of the lateral frame portion 13. Specifically, the vertical frame portions 14 include a left vertical frame portion 15 extending downward from a left end portion of the lateral frame portion 13 and a right vertical frame portion 16 extending downward from a right end portion of the lateral frame portion 13.

As described above, the arch-shaped frame 12 includes a lateral frame portion 13 extending laterally relative to the body and a pair of left and right vertical frame portions 14 extending downward from respective left end and right end portions of the lateral frame portion 13. Specifically, the arch-shaped frame 12 includes: a lateral frame portion 13 extending laterally relative to a body of the work vehicle; a left vertical frame portion 15 extending downward from a left end portion of the lateral frame portion 13; and a right vertical frame portion 16 extending downward from a right end portion of the lateral frame portion 13.

The left vertical frame portion 15 has a lower end portion coupled to a portion of the left lower frame portion 10 which portion is central in the front-back direction relative to the body. The right vertical frame portion 16 has a lower end portion coupled to a portion of the right lower frame portion 10 which portion is central in the front-back direction relative to the body.

As illustrated in FIGS. 2 to 4, the protective frame 11 includes a pair of left and right side frame members 20. The left side frame member 20 is at an upper left portion of the body of the work vehicle 1. The right side frame member 20 is at an upper right portion of the body of the work vehicle 1.

The side frame members 20 extend in the front-back direction relative to the body, and each include a front portion bent obliquely downward, a back portion bent downward, and a horizontal portion intermediate in the front-back direction relative to the body.

As described above, the work vehicle 1 includes a pair of left and right side frame members 20 extending in the front-back direction relative to the body. Expressions such as extending in the front-back direction relative to the body cover not only the state of extending exactly in the front-back direction relative to the body but also the state of extending substantially in the front-back direction relative to the body.

The side frame members 20 each have (i) a front end portion coupled to a front end portion of the corresponding lower frame portion 10 with a connector 21 in-between and (ii) a back end portion coupled to a back end portion of the corresponding lower frame portion 10.

The left side frame member 20 has an intermediate portion in the front-back direction relative to the body which intermediate portion is fixed to an upper end portion of the left vertical frame portion 15. The right side frame member 20 has an intermediate portion in the front-back direction relative to the body which intermediate portion is fixed to an upper end portion of the right vertical frame portion 16. In other words, the side frame members 20 each have an intermediate portion in the front-back direction relative to the body which intermediate portion is fixed to an upper end portion of the corresponding vertical frame portion 14.

### Occupant Space

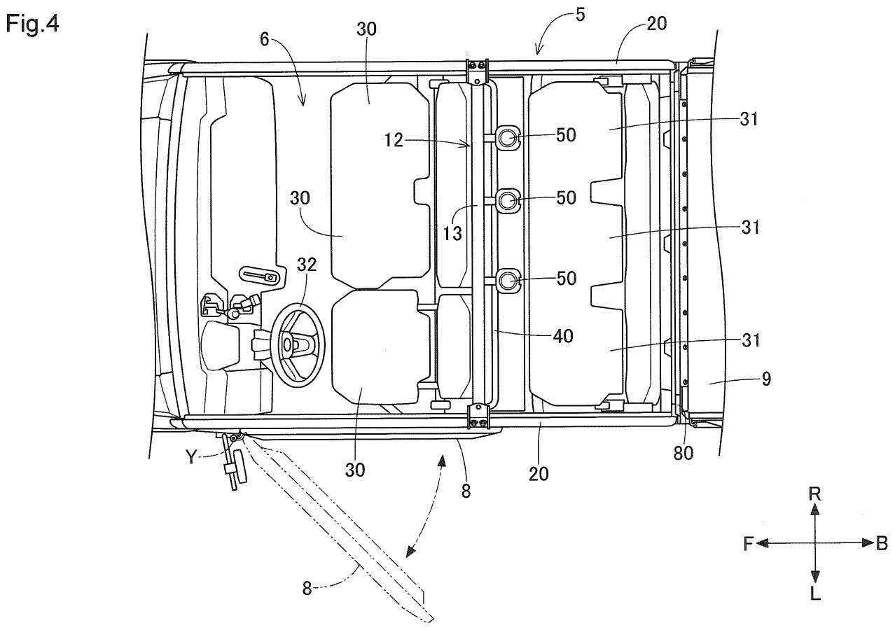

As illustrated in FIGS. 2 and 4, the work vehicle 1 includes in the occupant space 6 front seats 30 and back seats 31 backward of the front seats 30 relative to the body. The work vehicle 1 as the present embodiment includes three front seats 30 arranged laterally relative to the body and three back seats 31 arranged laterally relative to the body.

The present invention is not limited to the above configuration; the work vehicle 1 may alternatively include any number of front seats 30 other than three and any number of back seats 31 other than three.

The front seats 30 are forward of the arch-shaped frame 12, whereas the back seats 31 are backward of the arch-shaped frame 12.

The present embodiment is optionally configured such that the central and right front seats 30 are integral with each other and that the back seats 31 are all integral with one another.

The work vehicle 1 includes in the occupant space 6 a steering wheel 32 forward of the left front seat 30 for use by an occupant to steer the work vehicle 1.

### Handrail

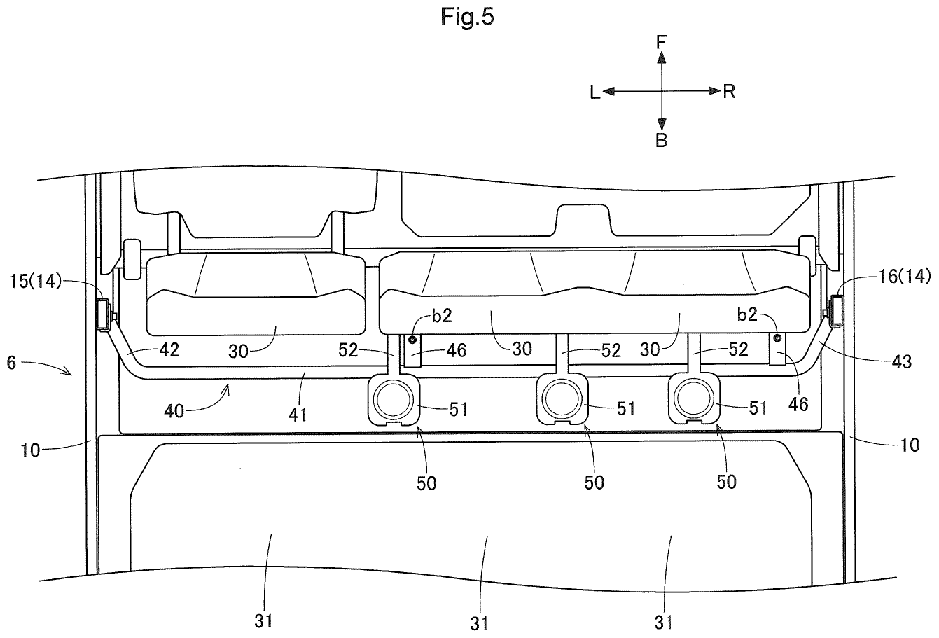

As illustrated in FIG. 5, the work vehicle 1 includes in the occupant space 6 a handrail 40 disposed between the front seats 30 and the back seats 31 in the front-back direction relative to the body for use by occupants on the back seat 31.

As described above, the work vehicle 1 includes a handrail 40 usable by occupants on the back seats 31.

The handrail 40 for the present embodiment is made of metal. The present invention is not limited to such a configuration; the handrail 40 may alternatively be made of any material other than metal.

The handrail 40 includes a first section 41, a second section 42, and a third section 43. The first section 41 extends laterally relative to the body. The second section 42 extends forward from a left end portion of the first section 41. The third section 43 extends forward from a right end portion of the first section 41.

As described above, the handrail 40 includes: a first section 41 extending laterally relative to the body; a second section 42 extending forward from a left end portion of the first section 41; and a third section 43 extending forward from a right end portion of the first section 41.

As illustrated in FIG. 5, the second section 42 is coupled to the left vertical frame portion 15, whereas the third section 43 is coupled to the right vertical frame portion 16.

The description below deals in detail with how the second section 42 is coupled to the left vertical frame portion 15. The third section 43 is coupled to the right vertical frame portion 16 similarly to how the second section 42 is coupled to the left vertical frame portion 15. The description below thus applies similarly to how the third section 43 is coupled to the right vertical frame portion 16.

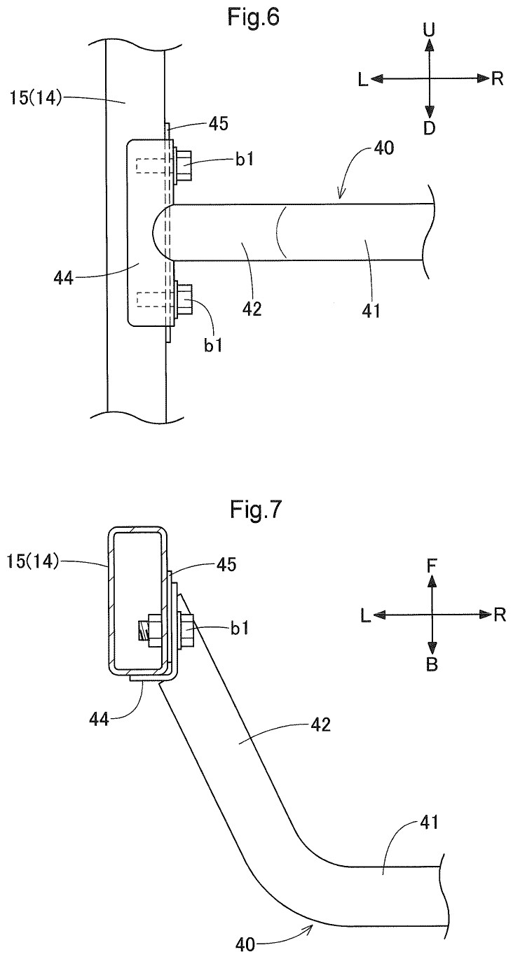

As illustrated in FIGS. 6 and 7, the handrail 40 includes a contact stay 44 coupled to a front end portion of the second section 42. As illustrated in FIG. 7, the contact stay 44 has an L shape in a plan view, and is fastened to the left vertical frame portion 15 with use of first bolts b1 on the right side relative to the body (that is, laterally inward relative to the body).

The left vertical frame portion 15 for the present embodiment has a substantially rectangular cross section as illustrated in FIG. 7. The handrail 40 includes between the right side face of the left vertical frame portion 15 and the contact stay 44 a plate 45 that may be fixed (for example, welded) to the left vertical frame portion 15 or the contact stay 44. The handrail 40 may alternatively omit the plate 45.

The number of first bolts b1 may be one or two or more.

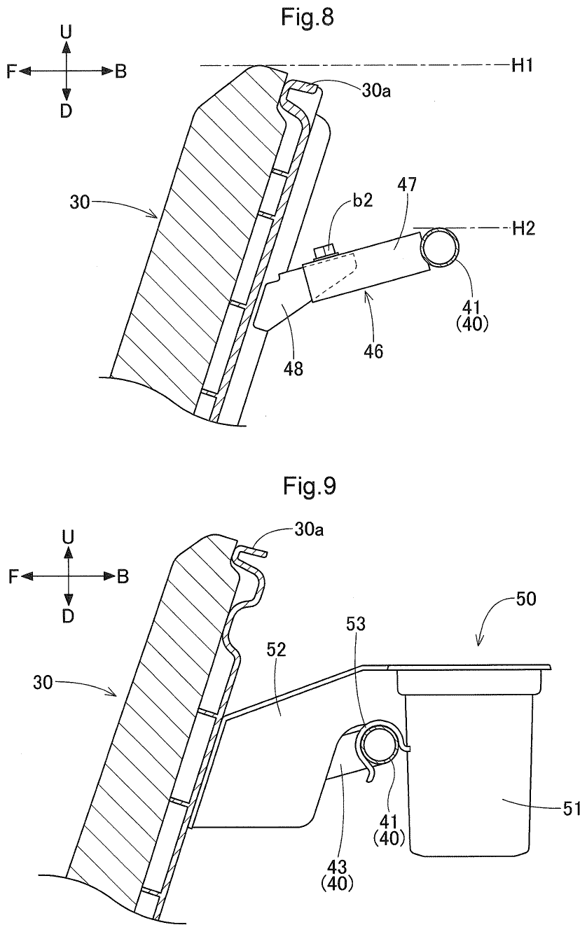

As illustrated in FIGS. 5 and 8, the handrail 40 includes two couplers 46 fixed to the first section 41 and each extending from the corresponding front seat 30 to the first section 41.

As described above, the work vehicle 1 includes couplers 46 extending from the handrail 40 to the front seats 30.

As illustrated in FIG. 8, the couplers 46 each include a back member 47 and a front member 48 each extending in the front-back direction relative to the body. The back member 47 has a back end portion fixed (for example, welded) to the first section 41. The front member 48 has a front end portion fixed (for example, welded) to the seat frame 30a at a back portion of the corresponding front seat 30. The back member 47 has a front end portion coupled to a back end portion of the front member 48 with use of a second bolt b2.

The above configuration allows the first section 41 to be coupled to each seat frame 30a with the back member 47 and the front member 48 in-between. In other words, the couplers 46 couple the handrail 40 to the front seats 30.

FIG. 8 shows H1 to indicate a first height and H2 to indicate a second height. The first height H1 corresponds to the position of the upper end of each front seat 30 (in other words, the height of the upper end or the position of the upper end in the up-down direction relative to the vehicle). The second height H2 corresponds to the position of the upper end of the first section 41. As illustrated in FIG. 8, the handrail 40 is positioned such that the second height H2 is below the first height H1.

As described above, the first section 41 has an upper end below the upper end of each front seat 30.

As illustrated in FIG. 4, the work vehicle 1 includes in the occupant space 6 drink holders 50 each disposed between the front seats 30 and the back seats 31 in the front-back direction relative to the body for use by an occupant on a back seat 31.

The present embodiment includes three drink holders 50. The present invention is, however, not limited to such a configuration; the number of drink holders 50 may be one or two or more.

As illustrated in FIG. 9, the drink holders 50 each include a drink holding section 51, an extended section 52, and an engagement section 53. The drink holding section 51 is configured to hold a drink container (for example, a cup or a plastic bottle). The extended section 52 extends forward from a front end portion of the drink holding section 51 to the corresponding seat frame 30a.

The engagement section 53 is fixed to a lower portion of the extended section 52 and engageable with the first section 41 from above.

Bringing a front end portion of the extended section 52 into contact with the corresponding seat frame 30a from behind and engaging the engagement section 53 with the first section 41 from above attaches the drink holder 50 to the first section 41. The drink holders 50 may each be configured such that disengaging the engagement section 53 from the first section 41 detaches the drink holder 50 from the first section 41.

As described above, the work vehicle 1 as the present embodiment includes drink holders 50 attached to the first section 41.

### First and Second Supports

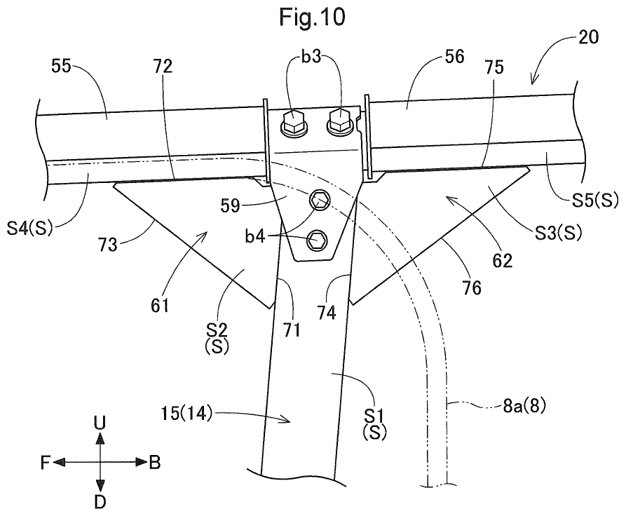

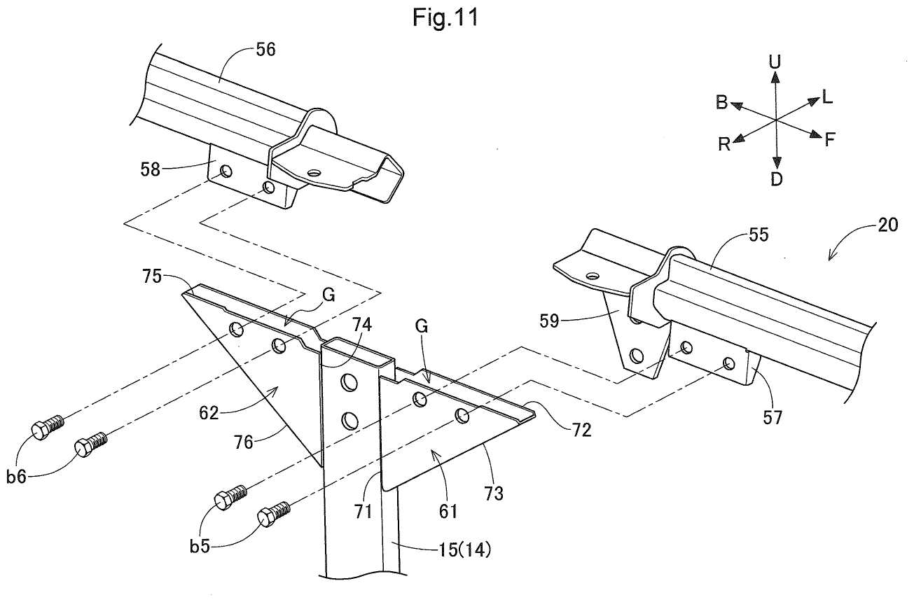

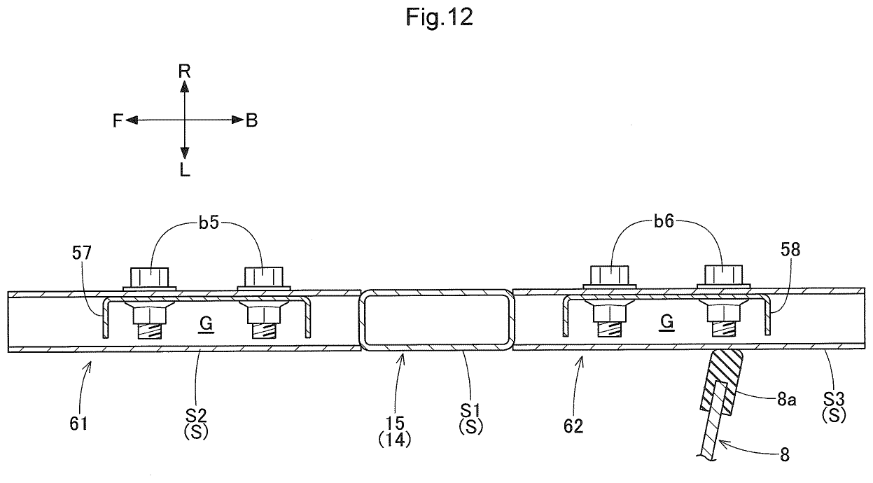

As illustrated in FIGS. 10 and 11, the side frame members 20 each include a front frame portion 55 and a back frame portion 56. The front frame portion 55 corresponds to a front portion of the side frame member 20, whereas the back frame portion 56 corresponds to a back portion of the side frame member 20. The front and back frame portions 55 and 56 extend in the front-back direction relative to the body.

As illustrated in FIG. 10, the front frame portion 55 has a back end portion coupled to a front end portion of the back frame portion 56 with use of third bolts b3. The number of third bolts b3 may be one or two or more.

As illustrated in FIG. 10, the work vehicle 1 includes a first support 61 and a second support 62 both fixed to an upper end portion of the left vertical frame portion 15. The work vehicle 1 also includes a first support 61 and a second support 62 both fixed to an upper end portion of the right vertical frame portion 16 similarly (not illustrated in the drawings). In other words, the work vehicle 1 includes a first support 61 and a second support 62 both fixed to an upper end portion of each vertical frame portion 14.

The description below deals in detail with the first and second supports 61 and 62 fixed to an upper end portion of the left vertical frame portion 15. The description below applies similarly to the first and second supports 61 and 62 fixed to an upper end portion of the right vertical frame portion 16.

As illustrated in FIG. 10, the first support 61 extends forward from a front upper end portion of the left vertical frame portion 15 (which is one of the vertical frame portions 14), whereas the second support 62 extends backward from a back upper end portion of the left vertical frame portion 15.

The first and second supports 61 and 62 are each in the shape of a triangle in a side view which triangle has a first side along the left vertical frame portion 15 and a second side along the side frame member 20.

Specifically, the first support 61 is in the shape of a substantial triangle in a side view which triangle has a first side 71, a second side 72, and a third side 73. The first side 71 extends along the left vertical frame portion 15 (that is, in the longitudinal direction of the left vertical frame portion 15). The second side 72 extends along the front frame portion 55 (that is, in the longitudinal direction of the front frame portion 55). The third side 73 is inclined with an upward front portion.

The second support 62 is in the shape of a substantial triangle in a side view which triangle has a fourth side 74, a fifth side 75, and a sixth side 76. The fourth side 74 extends along the left vertical frame portion 15 (that is, in the longitudinal direction of the left vertical frame portion 15).

The fifth side 75 extends along the back frame portion 56 (that is, in the longitudinal direction of the back frame portion 56). The sixth side 76 is inclined with an upward back portion.

The expression “the shape of a triangle in a side view” covers not only the shape of an exact triangle in a side view but also the shape of a substantial triangle in a side view.

The first support 61 includes a portion corresponding to the first side 71 which portion is

in contact with an upper end portion of the left vertical frame portion 15 from forward and is welded to the upper end portion. The second support 62 includes a portion corresponding to the fourth side 74 which portion is in contact with an upper end portion of the left vertical frame portion 15 from backward and is welded to the upper end portion.

As described above, the first and second supports 61 and 62 are each welded to an upper end portion of each vertical frame portion 14.

As illustrated in FIGS. 10 and 11, the front frame portion 55 includes a back end portion with an extended attachment section 59 extending downward and fastened to the left vertical frame portion 15 from the left side with use of fourth bolts b4. This allows the front frame portion 55 (which is included in the side frame member 20) to be coupled to the left vertical frame portion 15. The number of fourth bolts b4 may be one or two or more.

As illustrated in FIG. 11, the front frame portion 55 includes a back portion with a front attachment section 57 fixed thereto and extending downward from the front frame portion 55. The back frame portion 56 includes a front portion with a back attachment section 58 fixed thereto and extending downward from the back frame portion 56. The back portion of the front frame portion 55 and the front portion of the back frame portion 56 each correspond in position to a portion of the side frame member 20 which portion is intermediate in the front-back direction relative to the body. An “intermediate portion in the front-back direction relative to the body” refers to a portion between a front end portion and a back end portion in the front-back direction relative to the body.

As illustrated in FIGS. 11 to 13, the first and second supports 61 and 62 are each a substantially rectangular plate so bent as to have a substantially triangular shape in a side view.

The first and second supports 61 and 62 thus each have a gap G open upward.

The front attachment section 57 is inserted in the first support 61 through its gap G from above and fastened to the first support 61 with use of fifth bolts b5. This fixes the front frame portion 55 to the first support 61 with use of the front attachment section 57.

The back attachment section 58 is inserted in the second support 62 through its gap G

from above and fastened to the second support 62 with use of sixth bolts b6. This fixes the back frame portion 56 to the second support 62 with use of the back attachment section 58.

With the above configuration, the side frame members 20 each have an intermediate portion in the front-back direction relative to the body which intermediate portion is fixed to the first and second supports 61 and 62. Specifically, the side frame members 20 each have an intermediate portion in the front-back direction relative to the body which intermediate portion is bolted to the first and second supports 61 and 62.

### Flat Surface

As illustrated in FIGS. 1 and 4, the door 8 is swingable about a swing axis Y present at a front end portion of the door 8 and extending in the up-down direction relative to the body. This allows the door 8 to be opened and closed. FIG. 4 shows the door 8 in the open state with an imaginary line and the door 8 in the closed state with a solid line.

As illustrated in FIGS. 10, 12, and 13, the door 8 includes a seal member 8a disposed at an edge of the door 8 which edge is laterally inward relative to the body. The seal member 8a may be, for example, a weatherstrip. The seal member 8a is preferably flexible, and may be made of rubber, for example.

As illustrated in FIGS. 10, 12, and 13, the work vehicle 1 has a flat surface S formed by the left vertical frame portion 15 (which is one of the vertical frame portions 14), the first and second supports 61 and 62, and the corresponding side frame member 20 and facing laterally outward (specifically on the left side) relative to the body.

Specifically, the flat surface S is made up of first to fifth surface portions S1 to S5 flush with one another. The five surface portions, in other words, each face laterally outward (specifically on the left side) relative to the body and are at the same lateral position relative to the body.

The first surface portion S1 is of the left vertical frame portion 15 and faces laterally outward (specifically on the left side) relative to the body. The second surface portion S2 is of the first support 61 and faces laterally outward (specifically on the left side) relative to the body. The third surface portion S3 is of the second support 62 and faces laterally outward (specifically on the left side) relative to the body.

The fourth surface portion S4 is of a lower end portion of the front frame portion 55 and faces laterally outward (specifically on the left side) relative to the body. The fifth surface portion S5 is of a lower end portion of the back frame portion 56 and faces laterally outward (specifically on the left side) relative to the body.

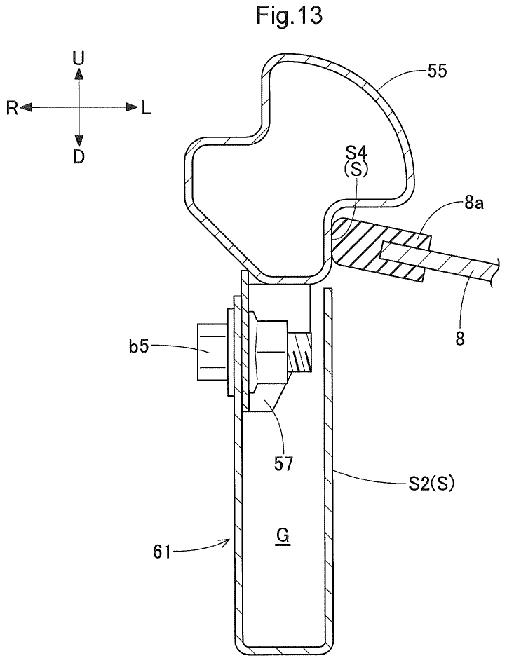

As illustrated in FIGS. 10, 12, and 13, the seal member 8a of the door 8 in the closed state is in contact with the flat surface S. Specifically, the seal member 8a of the door 8 in the closed state is in contact with the third surface portion S3 (see FIG. 12) and the fourth surface portion S4 (see FIG. 13) both from laterally outward (specifically from the left side) relative to the body.

As described above, the door 8 is in contact with the flat surface S when the door 8 is in the closed state.

### Net

As illustrated in FIGS. 3, 4, and 14, the work vehicle 1 includes a net 80 facing at least a portion of the occupant space 6.

Specifically, the net 80 is oriented vertically and faces at least a portion of the occupant space 6 from backward relative to the body. The net 80 for the present embodiment faces an upper portion of the occupant space 6 from backward relative to the body.

The present invention is not limited to the above configuration. The net 80 may alternatively be oriented in any manner other than vertically (for example, horizontally). The net 80 may alternatively face at least a portion of the occupant space 6 from any side other than backward (for example, from upward, the left side, or the right side) relative to the body. The net 80 may alternatively face a lower portion of the occupant space 6 or its entirety (that is, both the upper and lower portions).

As described above, the work vehicle 1 includes a net 80 facing at least a portion of the occupant space 6.

The net 80 for the present embodiment is between the occupant space 6 and the cargo box 9.

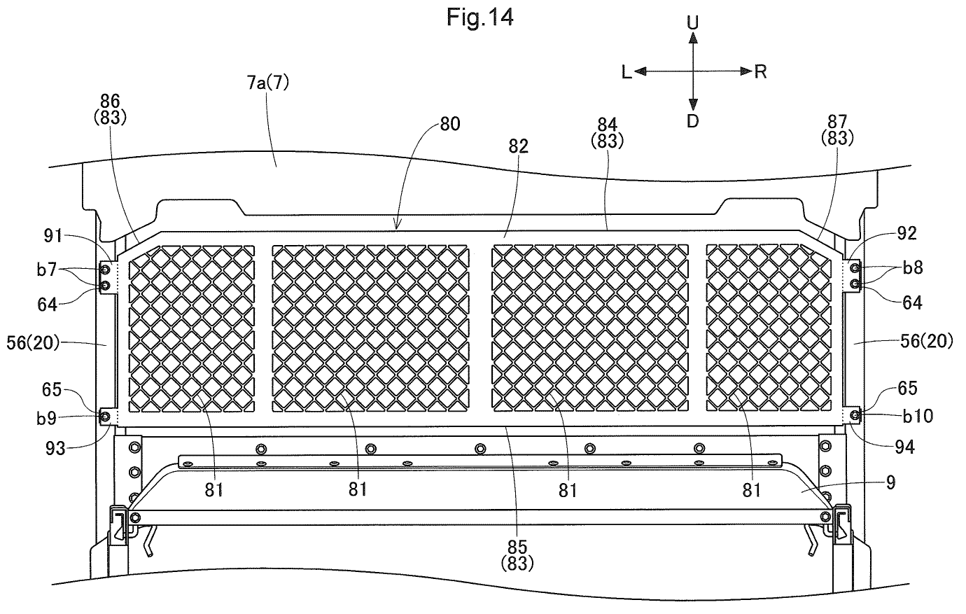

As illustrated in FIG. 14, the net 80 includes four net sections 81 laterally arranged relative to the body and each in the form of a net. The net sections 81 each allow an occupant in the occupant space 6 to see therethrough the outside of the occupant space 6 (specifically, backward of the occupant space 6).

The net 80 includes a frame 82 in the form of a window frame surrounding the net sections 81. The net 80, in other words, includes net sections 81 each in the form of a net and a frame 82 in the form of a window frame surrounding the net sections 81. The net 80 is made of a single metal plate.

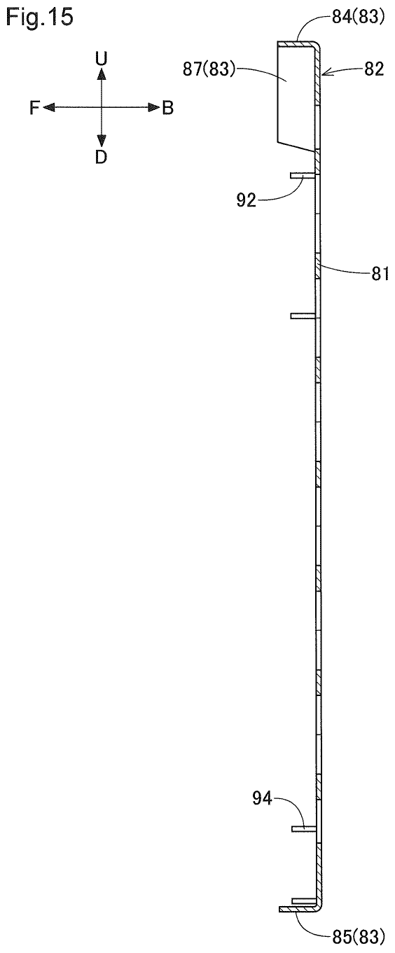

As illustrated in FIGS. 14 to 16, the frame 82 has an edge at least a portion of which is bent into a bend 83. Specifically, the frame 82 has at least an upper end portion and a lower end portion each having a bend 83.

The description below deals with the bend 83 in detail. The frame 82 for the present embodiment has an edge with an upper bend 84, a lower bend 85, an upper left bend 86, and an upper right bend 87 each in the form of a bend forward relative to the body to serve as a bend 83.

The upper bend 84 is at an upper end portion of the frame 82, and is oriented horizontally to extend laterally relative to the body. The upper bend 84 is between the upper left bend 86 and the upper right bend 87, and has a left end that may be coupled (for example, welded) to the right end of the upper left bend 86 and a right end that may be coupled (for example, welded) to the left end of the upper right bend 87.

The lower bend 85 is at a lower end portion of the frame 82, and is oriented horizontally to extend laterally relative to the body from the left end of the frame 82 to the right end thereof.

The upper left bend 86 is at an upper left end portion of the frame 82, and is inclined with an upward right portion.

The upper right bend 87 is at an upper right end portion of the frame 82, and is inclined with an upward left portion.

The frame 82 for the present embodiment includes no bend 83 at the left or right end.

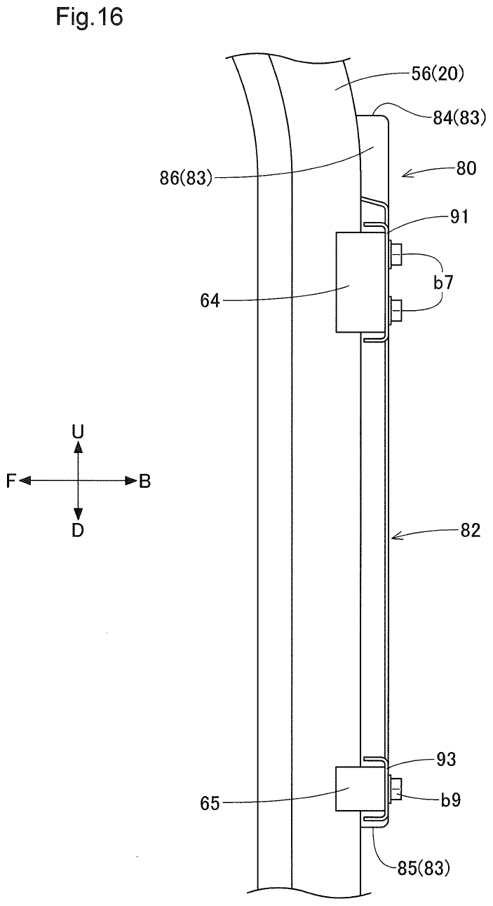

As illustrated in FIGS. 14 and 16, the back frame portions 56 each have a back end portion extending in the up-down direction relative to the body and provided with an upper stay 64 and a lower stay 65 below the upper stay 64 both fixed (for example, welded) to the back end portion.

The frame 82 is provided with first to fourth attachment sections 91 to 94 each fixed (for example, welded) to its edge and in the shape of a channel.

The first attachment section 91 is fixed to an upper portion of the left end of the frame 82. The second attachment section 92 is fixed to an upper portion of the right end of the frame 82. The third attachment section 93 is fixed to a lower portion of the left end of the frame 82. The fourth attachment section 94 is fixed to a lower portion of the right end of the frame 82.

The first attachment section 91 is fastened to the left upper stay 64 with use of seventh bolts b7. The second attachment section 92 is fastened to the right upper stay 64 with use of eighth bolts b8. The third attachment section 93 is fastened to the left lower stay 65 with use of a ninth bolt b9. The fourth attachment section 94 is fastened to the right lower stay 65 with use of a tenth bolt b10.

The above configuration allows the net 80 to be coupled to respective back end portions of the back frame portions 56 with use of the first to fourth attachment sections 91 to 94. In other words, the net 80 is coupled to the side frame members 20. The respective numbers of seventh to tenth bolts b7 to b10 may each be one or two or more.

As illustrated in FIG. 14, the roof 7 includes at a back portion a back roof frame member 7a. The back roof frame member 7a extends from the left back frame portion 56 to the right back frame portion 56, and is coupled to the back frame portions 56. The back roof frame member 7a may be coupled to the net 80 with use of, for example, a coupling stay (not illustrated in the drawings).

The above configuration allows the left and right vertical frame portions 15 and 16 to be coupled to each other with the handrail 40 in-between, thereby allowing the handrail 40 to ensure the strength of the arch-shaped frame 12. The above configuration reduces the number of parts involved, as compared to a case of including a handrail 40 as well as a reinforcing frame member separately from the handrail 40 to couple the left and right vertical frame portions 15 and 16 to each other, and thereby prevents an increase in the production cost.

The above configuration allows the first section 41 to be backward, as compared to a case of a handrail 40 including no second section 42 or third section 43. The handrail 40 described above is thus easily usable for a user with relatively short arms such as a child, thereby providing improved convenience for occupants on the back seats 31.

The work vehicle 1 configured as above offers improved convenience for occupants on the back seats 31 without increasing the production cost.

### Alternative Embodiments

(1) The elements described above may each be positioned laterally opposite.
(2) The work vehicle 1 may include an electric motor instead of an engine as a motive power source, or may be a hybrid work vehicle including both an engine and an electric motor.
(3) The couplers 46 may be absent.
(4) The first section 41 may have an upper end above the upper end of each front seat 30.
(5) The drink holders 50 may be absent.
(6) The first and second supports 61 and 62 may each have any shape in a side view.
(7) The door 8 may be absent.
(8) The first and second supports 61 and 62 may each be fixed to the corresponding vertical frame portion 14 in any manner other than welding.
(9) The side frame members 20 may each be fixed to the corresponding first and second supports 61 and 62 in any manner other than bolting.
(10) The frame 82 may include a bend 83 at each of the left and right ends.
(11) The frame 82 may include no bend 83 at each of the upper end and lower end portions.
(12) The cargo box 9 may be absent.
(13) The net 80 may be uncoupled to the side frame members 20.
(14) The first to fourth attachment sections 91 to 94 may be included in the net 80.
(15) The net 80 may be made of two or more members.

The arrangements disclosed for the above embodiments (including the alternative embodiments; hereinafter the same applies) may each be combined with an arrangement disclosed for another embodiment, as long as such a combination does not cause a contradiction. Further, the embodiments disclosed in the present specification are mere examples. The present invention is not limited to those embodiments, and may be altered as appropriate, as long as such an alteration does not result in a failure to attain an object of the present invention.

### Industrial Applicability

The present invention is applicable to a work vehicle having a space for an occupant.

1. A work vehicle, comprising:
an occupant space configured to accommodate an occupant;
an arch-shaped frame extending over the occupant space and comprising:
a lateral frame portion extending laterally relative to a body of the work vehicle;
a left vertical frame portion extending downward from a left end portion of the lateral frame portion; and
a right vertical frame portion extending downward from a right end portion of the lateral frame portion;
a front seat in the occupant space;
a back seat in the occupant space and backward of the front seat relative to the body; and
a handrail usable by an occupant on the back seat and comprising:
a first section extending laterally relative to the body;
a second section extending forward from a left end portion of the first section; and
a third section extending forward from a right end portion of the first section,
wherein the second section is coupled to the left vertical frame portion, and
wherein the third section is coupled to the right vertical frame portion.

2. The work vehicle according to claim 1, further comprising:
a coupler extending from the handrail to the front seat and coupling the handrail to the front seat.

3. The work vehicle according to claim 1, wherein:
the first section has an upper end below an upper end of the front seat.

4. The work vehicle according to claim 1, wherein:
the handrail is made of metal.

5. The work vehicle according to claim 1, further comprising:
a drink holder attached to the first section.
